(19) United States
(12) Patent Application Publication
(10) Pub. No.: US 2025/0280423 A1
(43) Pub. Date: Sep. 4, 2025

(54) METHODS IN DETERMINING THE APPLICATION DELAY FOR SEARCH-SPACE SET GROUP-SWITCHING

(71) Applicant: Telefonaktiebolaget LM Ericsson (publ), Stockholm (SE)

(72) Inventors: Ilmiawan SHUBHI, Malmö (SE); Ajit NIMBALKER, Dublin, CA (US); Sina MALEKI, Malmö (SE)

(21) Appl. No.: 18/858,833

(22) PCT Filed: Apr. 25, 2023
(86) PCT No.: PCT/SE2023/050373

§ 371 Date: Oct. 22, 2024

Related U.S. Application Data
(60) Provisional application No. 63/334,358, filed on Apr. 25, 2022.

(51) Int. Cl. H04W 72/231; H04W 72/51; H04W 76/20

(52) U.S. Cl. CPC H04W 72/231; H04W 72/51; H04W 76/20

(57) ABSTRACT

A method performed by a user equipment (UE) for search-space set group, SSSG, switching. The method includes transmitting UE capability information to a network node, where the transmitted UE capability information determines an application delay. The method further includes monitoring PDCCH candidates according to a first SSSG. Furthermore, the method includes receiving an indication, from the network node, to switch from monitoring PDCCH candidates according the first SSSG to monitor PDCCH candidates according to a second SSSG. Finally, the method includes monitoring PDCCH candidates according to a second SSSG after the application delay. There is also provided a UE, a network node and a method for the network node.

### TECHNICAL FIELD

The present disclosure relates to wireless communications and, in particular, to determining the application delay for the Search-Space Set groups.

### BACKGROUND

Physical downlink control channel (PDCCH) monitoring during the active time is one of the most power-consuming operations of a user equipment (UE). In fact, monitoring for PDCCH candidates in the absence of data may be the dominant source of energy consumption in enhanced mobile broadband (eMBB). Therefore, techniques that can reduce unnecessary PDCCH monitoring occasions (MOs), i.e., allowing UE to go to sleep or wake up (e.g., to monitor PDCCH) only when required can be beneficial.

In NR (new radio), one of the mechanisms to reduce the PDCCH monitoring is the search-space set group (SSSG)-switching. In SSSG-switching, a UE can be configured with more than one (e.g., two) SSSGs, and the UE can be indicated to switch between those SSSGs. Exploiting the SSSG-switching for UE power-saving can be done for example by configuring one SSSG (e.g., SSSG0) to have sparse PDCCH MOs and another SSSG (e.g., SSSG1) to have dense PDCCH MOs. The UE monitors PDCCH according to the sparse SSSG when there are no data bursts and switches to the dense SSSG when data burst are received. The UE may switch back to the sparse SSSG when the data burst ends.

To indicate that the UE is capable of supporting SSSG-switching, the UE may transmit capability information to the network (NW). For Rel. 17, there are 3 capability information related to the SSSG-switching, which are:
a, support 2 SSSG-switching: which informs that the UE is capable to be configured with up to 2 SSSGs without PDCCH-skipping feature.
b, support 3 SSSG-switching: which informs that the UE is capable to be configured with up to 3 SSSGs without PDCCH-skipping feature.
c, support 2 SSSG-switching with PDCCH-skipping: which informs that the UE is capable to be configured with up to 2 SSSGs simultaneously with PDCCH-skipping feature.
   The UE capabilities/features are shown in Table 1 below:

TABLE 1
The UE capabilities/features

| | | | | Prerequisite |
|---|---|---|---|---|
| | | | | feature |
| Features | Index | Feature group | Components | groups |
| 29. | 29-3b | 2 search space sets | Support of 1-bit indication of SSSG switching between 2 | |
| NR_UE_pow_{—} | | group switching | SSSGs by scheduling DCI, and timer based SSSG switching, | |
| sav_enh | | | if PDCCHSkippingDurationList is not configured | |
| 29. | 29-3c | 3 search space sets | Support of 2-bit indication of SSSG switching among 3 | 29-3b |
| NR_UE_pow_{—} | | group switching | SSSGs by scheduling DCI and timer based SSSG switching, if | |
| sav_enh | | | PDCCHSkippingDurationList is not configured | |
| 29. | 29-3d | 2 search space sets | Support of 2-bit indication of SSSG switching between 2 | 29-3a, 29-3b |
| NR_UE_pow_{—} | | group switching with | SSSGs, PDCCH skipping by scheduling DCI, and timer based | |
| sav_enh | | PDCCH skipping | SSSG switching | |

In SSSG-switching, when a UE is in a first SSSG and is indicated, either explicitly via DCI or implicitly via SSSG-switching timer expiration, to switch to a second SSSG, the UE will monitor PDCCH according to the second SSSG after a certain application delay.

According to Rel-16 SSSG-switching, a UE can be configured with a searchSpaceSwitchDelay. The parameter searchSpaceSwitchDelay may be given in a number of symbols, Pswitch. The minimum value of Pswitch is provided in Table 10.4-1 for UE processing capability 1 and UE processing capability 2 and SCS configuration u. UE processing capability 1 for SCS configuration u applies unless the UE indicates support for UE processing capability 2.
searchSpaceSwitchDelay is defined in TS 38.331.
searchSpaceSwitchDelay.
“Indicates the value to be applied by a UE for Search Space Set Group switching; corresponds to the P value in TS 38.213 [13], clause 10.4. The network configures the same value for all BWPs of serving cells in the same CellGroupForSwitch.”

The minimum of Pswicth is provided by Table 10.4-1 in TS 38.213 (Table 2) as shown below.

TABLE 2
Minimum Pswitch values for different
numerologies and UE capability

P_{switch} value

| Numerology | UE cap1 | UE cap2 |
|---|---|---|
| 0 | 25 symbols | 10 symbols |
| 1 | 25 symbols | 12 symbols |
| 2 | 25 symbols | 22 symbols |
| 3 | 40 symbols | — |
| 5 | 160 symbols | — |
| 6 | 320 symbols | — |

As can be seen above, there will be two possible minimum Pswitch values for a given numerology. One Pswitch vale is applicable to a UE with processing capability 1 (cap1) and the other value is applicable to a UE with processing capability 2 (cap2).

For Rel. 17 SSSG-switching, the UE will monitor PDCCH according to the second SSSG at a first slotat least Pswitch symbol after the last symbols of the PDCCH that indicates the switch. According to the 3GPP agreements, the Pswitch value will follow the table in TS 38.213 section 10.4. The following is captured from the 3GPP agreements.

### Agreement

For Rel-17 search space set group switching, the following is supported:

Upon detecting a scheduling DCI format 1-1/1-2/0-1/0-2 indicating SSSG switching (i.e., Beh 2/2A/2B),
a, the UE applies SSSG switching on an active BWP of the serving cell at a first slot that is at least P_{switch} symbols after the last symbol of the PDCCH reception
   i. FFS: a minimum applicable scheduling offset is configured in the BWP
b. Note: P_{switch} is defined in Table 10.4-1 in TS38.213

There currently exist certain challenge(s). As mentioned above, for a given numerology, there will be 2 possible values of P_{switch} depending on the UE processing capability. In Rel. 17, however, support for SSSG-switching is indicated by the UE without considering this processing capability information. Therefore, it will not be clear to the UE (and to the NW), which P_{switch} value should be used as the transition time when switching from the first SSSG to the second SSSG and vice versa. If the UE applies an incorrect application delay, i.e., an incorrect P_{switch} value, the UE and the NW may not be sync'ed, and thus, the UE may miss one or more PDCCHs (and its corresponding PDSCH, uplink grant, etc.).

### SUMMARY

Certain aspects of the disclosure and their embodiments may provide solutions to these or other challenges. In the embodiments a method to support SSSG switching for advanced capability 2 via DCI formats such as Formats 1-1/1-2/0-1/0-2 is introduced. Further, the use of RRC parameter searchSpaceSwitchDelay in determining the applied application delay of Rel. 17 SSSG-switching is disclosed.

In some embodiments there is provided a method, in a wireless device. The method includes the steps of transmitting a capability associated with a band of licensed spectrum indicating support of Rel-17 SSSG switching with an advanced P_{switch} time, receiving RRC configuration associated with SSSG-switching and determining the application delay based on at least one of: a predetermined application delay, e.g. written in the standard and a RRC configuration related to the SSSG-switching application delay. The RRC configuration may be the Rel. 16 searchSpaceSwitchDelay and the Rel. 16 searchSpaceSwitchDelay may be interpreted differently for Rel. 17 SSSG-switching. Some embodiments advantageously provide methods, systems, and apparatuses for determining the application delay for SSSG-switching.

In one embodiment there is provided a method. The method performed by a user equipment (UE) for search-space set group. SSSG, switching. The method includes transmitting UE capability information to a network node, where the transmitted UE capability information determines an application delay. The method further includes monitoring PDCCH candidates according to a first SSSG. Furthermore, the method includes receiving an indication, from the network node, to switch from monitoring PDCCH candidates according the first SSSG to monitor PDCCH candidates according to a second SSSG. Finally, the method includes monitoring PDCCH candidates according to a second SSSG after the application delay.

In one embodiment there is provided a method. The method is performed by a network node for search-space set group. SSSG, switching. The method includes receiving UE capability information from a UE, where the transmitted UE capability information determines an application delay and wherein the application delay determines a delay when the UE switches from monitoring PDCCH candidates according to a first SSSG to monitoring PDCCH candidates according to a second SSSG. The method further includes transmitting (302) an indication, to the UE, to switch from monitoring according the first SSSG to monitor PDCCH candidates according to a second SSSG.

In one embodiment there is provided a user equipment (UE). The UE is configured for SSSG switching. The UE includes processing circuitry configured to transmit UE capability information to a network node, where the transmitted UE capability information determines an application delay. The processing circuitry is further configured to monitor PDCCH candidates according to a first SSSG. Furthermore, the processing circuitry is configured to receive an indication, from the network node, to switch from monitoring PDCCH candidates according the first SSSG to monitor PDCCH candidates according to a second SSSG. Finally, the processing circuitry is configured to monitor PDCCH candidates according to a second SSSG after the application delay.

In one embodiment there is provided a network node. The network node is configured for search-space set group. SSSG, switching. The network node includes processing circuitry configured to receive UE capability information from a UE, where the transmitted UE capability information determines an application delay and wherein the application delay determines a delay when the UE switches from monitoring PDCCH candidates according to a first SSSG to monitoring PDCCH candidates according to a second SSSG. The processing circuitry is further configured to transmit an indication, to the UE, to switch from monitoring according the first SSSG to monitor PDCCH candidates according to a second SSSG.

Certain embodiments may provide one or more of the following technical advantage(s). Using the embodiments disclosed herein, the UE can indicate support for advanced P_{switch} time. Thereby, smaller P_{switch} times associated with capability 2 processing may be utilized by the UE. In addition, both the UE and NW will be aware of the application delay that is applied to the SSSG-switching and thus, the UE and the NW will apply the indicated SSSG at the same time. This will avoid the mismatch between the UE and the NW that could result in an incorrect P_{switch} value and that the UE misses PDCCHs transmitted by the NW.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a flowchart of an example process in a wireless device according to some embodiments of the present disclosure

FIG. 2 is a flowchart of an example process in a wireless device according to some embodiments of the present disclosure:

FIG. 3 is a flowchart of an example process in a network node according to some embodiments of the present disclosure:

FIG. QQ1 shows an example of a communication system QQ100 in accordance with some embodiments:

FIG. QQ2 shows a UE QQ200 in accordance with some embodiments. As used herein:

FIG. QQ3 shows a network node QQ300 in accordance with some embodiments

FIG. QQ4 is a block diagram of a host QQ400, which may be an embodiment of the host QQ116 of Figure QQ1, in accordance with various aspects described herein:

FIG. QQ5 is a block diagram illustrating a virtualization environment QQ500 in which functions implemented by some embodiments may be virtualized:

FIG. QQ6 shows a communication diagram of a host QQ602 communicating via a network node QQ604 with a UE QQ606 over a partially wireless connection in accordance with some embodiments;

### DETAILED DESCRIPTION

Some of the embodiments contemplated herein will now be described more fully with reference to the accompanying drawings. Embodiments are provided by way of example to convey the scope of the subject matter to those skilled in the art. The physical downlink control channel, PDCCH, carries Downlink Control Information, (DCI). The UE may obtain control information by monitoring CORESET at a designated monitoring occasion, MO. This process is implemented by performing a so-called blind detection in the candidate set, i.e, set of PDCCH Candidates, in the configured search space. The search space indicates the set of control channel elements (CCE) locations where the UE may find its PDCCHs. Each PDCCH carries one DCI and is identified by Radio Network Temporary Identifier (RNTI). Similarly, a set of PDCCH candidates for a UE to monitor is defined in terms of PDCCH search space sets. A search space set can be a Common Search Space (CSS) set or a UE-specific Search Space (USS) set. A UE monitors PDCCH candidates in one or more of the search spaces sets. The UE finds the PDCCH specific to it by monitoring a set of PDCCH candidates in every subframe. The UE uses its RNTI to try and decode PDCCH candidates. The RNTI is used to demask a PDCCH candidate's CRC. If no CRC error is detected the UE determines that PDCCH carries its own control information. Through-out the embodiments the terms “PDCCH candidate” and “PDCCH” are interchangeably used.

In SSSG-switching, a UE can be configured with more than one (e.g., two) SSSGs, and the UE can be indicated to switch between those SSSGs. Exploiting the SSSG-switching for UE power-saving can be done for example by configuring one SSSG (e.g., SSSG0) to have sparse PDCCH monitoring occasions (MOs) and another SSSG (e.g., SSSG1) to have dense PDCCH MOs.

In the embodiments, it is assumed that the UE is capable to support the SSSG-switching feature. It is further assumed that the UE is configured with one or more search spaces, SSs, where each of the SS is configured with one or more SSSG indexes. Accordingly, the UE monitors according to a first SSSG and, after receiving an indication, switches to a second SSSG. The SSSGs may potentially include SSs configured such that they are at least different on one of the underlying SS configuration parameters, e.g., SS periodicity, duration, offset, etc., between different groups. In one example, the SS configurations in different groups are at least different in SS periodicity. The switching mechanism can be conducted via explicit indication via scheduling DCI, for example DCI 0-0, 0-1, 1-0, and 1-1, or via implicit indication, for example, via SSSG-switching timer expiration. In addition, the UE may be a UE with processing capability 1 (cap1) or with processing capability 2 (cap2).

The methods to determine the application delay of the SSSG-switching feature based on, at least, the UE processing capability, are now being described throughout the embodiments. In some embodiments, it is focused on the case where the UE is configured with two SS groups by the NW through higher layer signaling, e.g., RRC signaling. Nevertheless, the example embodiments can be readily extended to the case where the UE is configured with more than two SS groups. Some of the embodiments are described from a UE perspective. However, it should be understood that the embodiments implicitly also include corresponding steps carried out by the NW.

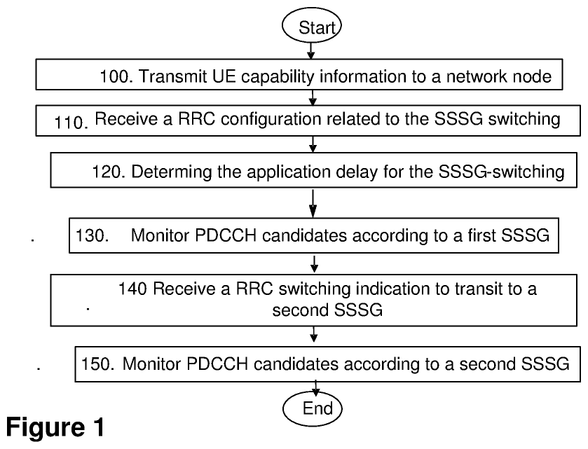

In some embodiments the method steps performed by the UE are: Step 100 Transmitting UE capability information to the NW, Step 110 Receiving RRC configuration related to the SSSG-switching feature, Step 120 Determining the application delay for the SSSG-switching. Step 130 Monitoring PDCCH according to a first SSSG, Step 140 Receiving a switching indication to transit to a second SSSG and Step 150 Monitoring PDCCH according to the second SSSG, as shown in FIG. 1.

In step 100, the UE transmits its capability information to the NW, i.e., the UE transmits its capability to support SSSG-switching. In one embodiment, the “main” SSSG-switching capability information is the same regardless of the UE processing capability. Thus, a UE with processing capability 1 and a UE with processing capability 2 may transmit the same SSSG-switching capability information to the NW, e.g., “support 2 SSSG-switching, support 3 SSSG-switching, etc.”. To indicate that the UE supports SSSG-switching with processing capability 2, an additional capability information may be introduced, e.g., “support SSSG-switching capability 2”. In an example of the embodiment, for the 2 SSSG-switching case, the UE that supports processing capability 1 may transmit only capability information of “support 2 SSSG-switching” to indicate that it is capable of supporting SSSG-switching with 2 SSSGs. The same mechanism may be used by the UE supporting processing capability 2 but wants to be served with the SSSG-switching application delay associated with processing capability 1. The UE may then.only transmit capability information of “support 2 SSSG-switching”. Contrary, if the UE supports processing capability 2 and wants to be served with the SSSG-switching application delay associated with processing capability 2, the UE may need to transmit both capability information of “support 2 SSSG-switching” and “support SSSG-switching capability 2”.

In an example of embodiment, the following capability may be added to the UE feature table.

TABLE 3
Added UE capability

| | | | | Prerequisite |
|---|---|---|---|---|
| | | | | feature |
| Features | Index | Feature group | Components | groups |
| 29. | 29-3e | Support Search space | Search space set group switching Capability-2 according to | 29-3b |
| NR_UE_pow_{—} | | set group switching | Table 10.4-1 of 38.213 for SSSG switching based on | |
| sav_enh | | capability 2 | scheduling DCI. | |

In Step 120, the UE determines the application delay that should be applied during the SSSG-switching. In one embodiment, the UE may determine the applied application delay based on the predetermined P_{switch} value correspond to the UE processing capability. For example, a UE transmitting the capability to support of SSSG-switching with processing capability 1 (e.g., by transmitting capability information of “support 2 SSSG-switching”) may use P_{switch} value predetermined for a UE with processing capability 1. In contrary, if the UE transmitting the capability to support SSSG-switching with processing capability 2 (e.g., by transmitting both capability information of “support 2 SSSG-switching” and “support SSSG-switching capability 2”). The UE may use the P_{switch} value predetermined for a UE with processing capability 2. In an example of realization, the predetermined P_{switch} value may be the same with the values consisted in Table 10.4-1 of TS 38.213, i.e., the P_{switch} values are {25, 25, 40, 160, 320} and {10, 12, 22} for processing capability 1 and 2, respectively.

In another embodiment, the UE may determine the application delay based on additional RRC configuration related to the SSSG-switching. For example, an explicit P_{switch} value may be configured for the UE via RRC (e.g., using either the existing searchSpaceSwitchDelay parameter or a new searchSpaceSwitchDelay-r17 parameter) and one of the predetermined application delays (either the predetermined application delay for processing capability 1 or the predetermined application delay for processing capability 2) is used as a baseline. In an example of embodiment, the UE may be configured (e.g., via standardization), to use the predetermined application delay for processing capability 1 as the baseline. I.e., if searchSpaceSwitchDelay (or searchSpaceSwitchDelay-r17) is not configured explicitly in the RRC, the UE will use the predetermined application delay for processing capability 1 as its applied application delay. On the other hand, if searchSpaceSwitchDelay (or searchSpaceSwitchDelay-r17) is configured in the RRC, the UE uses the value configured in that parameter.

Note that if one of the two options above is used, there will be differentiation on the mechanism in determining the application delay for Rel. 16 SSSG-switching and Rel. 17 SSSG-switching, i.e., because for Rel. 16 SSSG-switching, the P_{switch} value is determined purely from the RRC configuration (via searchSpaceSwitchDelay parameter).

In Step 130, the UE monitors PDCCH according to the first SSSG. Note that this step may be conducted simultaneously with Step 100-Step 120 above.

In Step 140, the UE receives a switching indication to transit to the second SSSG. The switching indication can be either explicit indication or an implicit indication. For example, the UE may receive the explicit indication via scheduling DCI. In another example, the UE may receive an implicit indication, e.g., via SSSG-switching timer expiration, transmitting a scheduling request (SR), etc.

In Step 150, the UE monitors PDCCH according to the second SSSG after the application delay. For example, the UE may monitor PDCCH according to the second SSSG at a first slot that at least P_{switch} symbols after the last PDCCH symbols containing the DCI indicating the switching. In another example, the UE may monitor PDCCH according to the second SSSG at a first slot that at least P_{switch} symbols after the SSSG-switching expires or P_{switch} symbols after the UE transmitting an SR. The value of P_{switch} follows the value determined in Step 120 above.

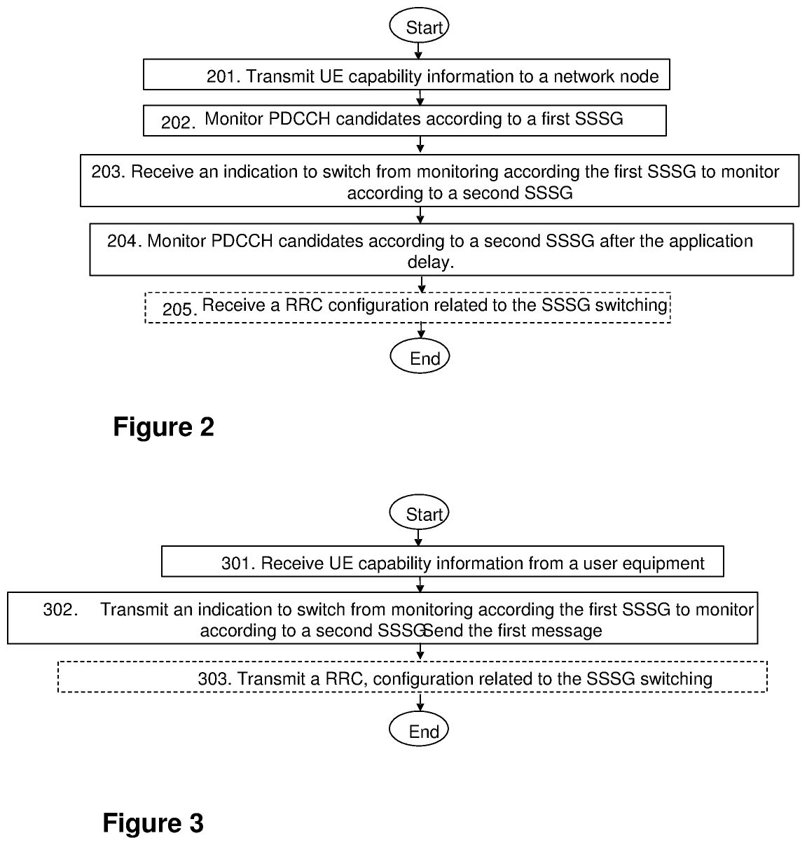

In some embodiments (FIG. 2) there is provided a method performed by a UE for search-space SSSG switching. The method includes in step 201 transmitting UE capability information to a network node. The transmitted UE capability information determines an application delay. The method further includes monitoring PDCCH candidates, in step 202, according to a first SSSG. Furthermore, the method includes step 203, receiving an indication, from the network node, to switch from monitoring according the first SSSG to monitor PDCCH candidates according to a second SSSG. Finally, the method includes step 204, monitoring PDCCH candidates according to a second SSSG after the application delay. Optionally, the method includes step 205, receiving, from the network node, a radio resource control. RRC, configuration related to the SSSG switching, wherein the application delay value is comprised in the RRC configuration related to the SSSG switching.

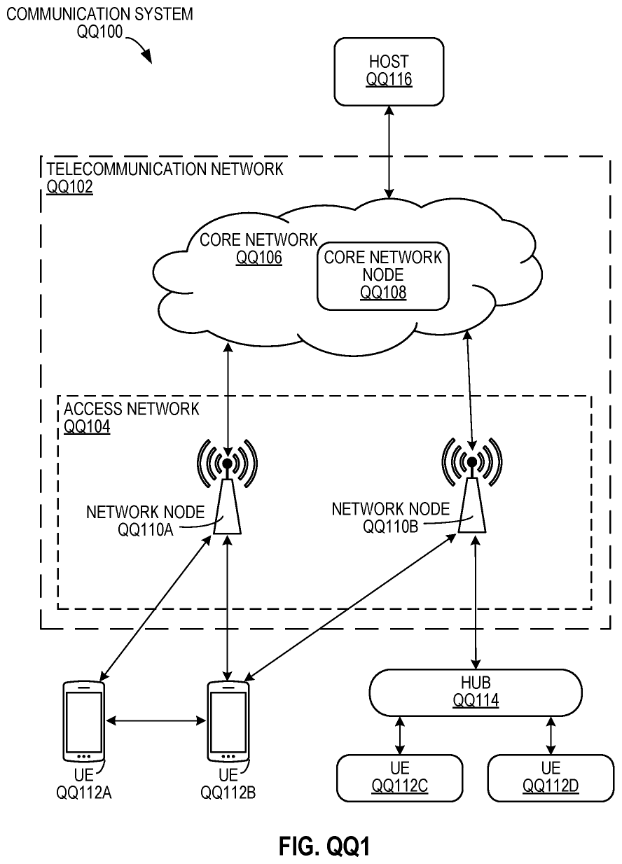

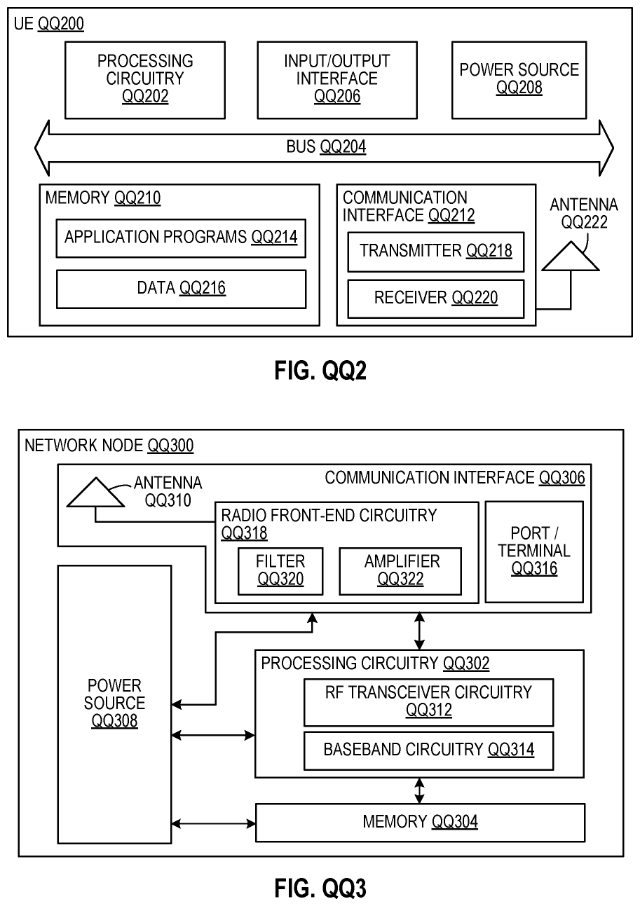

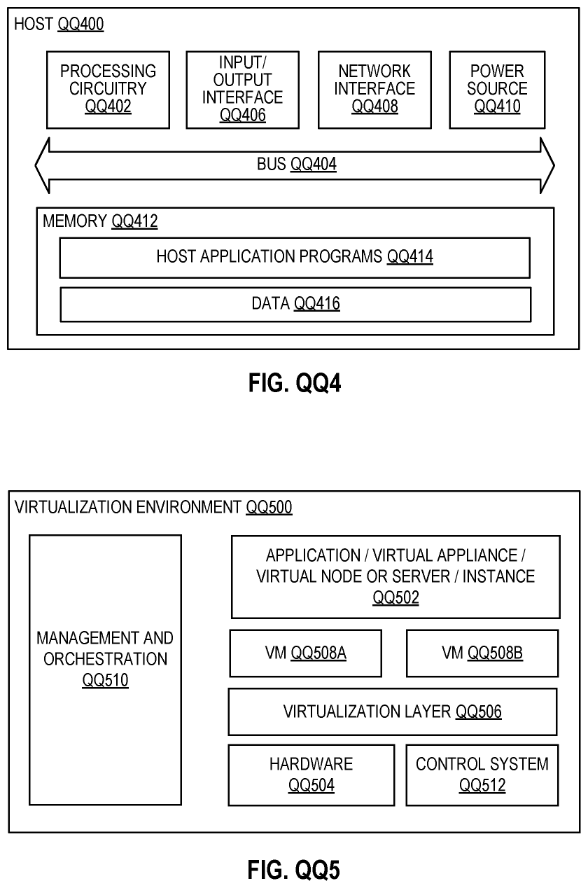

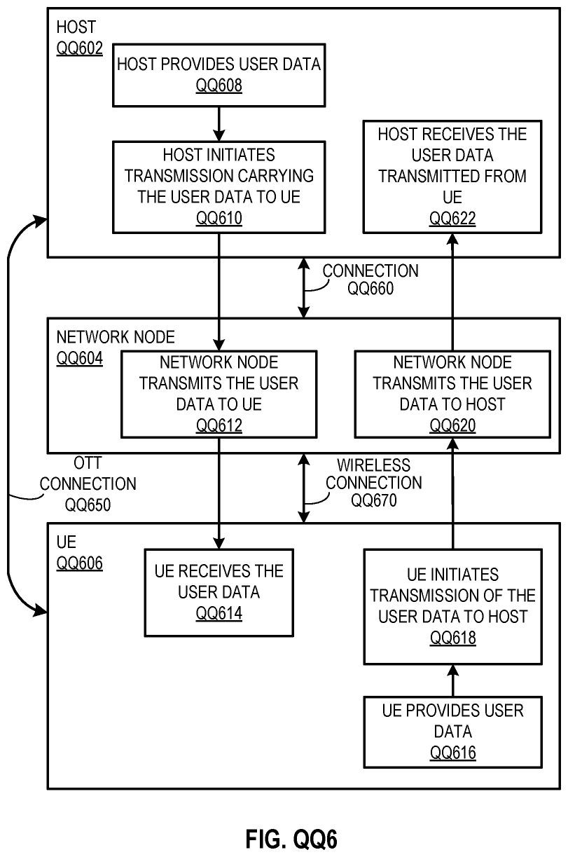

In some embodiments (FIG. 3) there is provided a method performed by a network node for search-space set group. SSSG, switching, the method includes, in step 301, receiving UE capability information from a user equipment. UE. The transmitted UE capability information determines an application delay and wherein the application delay determines a delay when the UE switches from monitoring PDCCH candidates according to a first SSSG to monitoring PDCCH candidates according to a second SSSG. The method further includes, step 302, transmitting an indication, to the UE, to switch from monitoring according the first SSSG to monitor PDCCH candidates according to a second SSSG. Optionally, the method includes, step 303, transmitting, to the UE, a radio resource control. RRC, configuration related to the SSSG switching, where the application delay value is comprised in the RRC configuration related to the SSSG switching.

Figure QQ1 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC). Mobility Management Entity (MME). Home Subscriber Server (HSS). Access and Mobility Management Function (AMF). Session Management Function (SMF). Authentication Server Function (AUSF). Subscription Identifier De-concealing function (SIDF). Unified Data Management (UDM). Security Edge Protection Proxy (SEPP). Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of Figure QQ1 enables connectivity between the UEs, network nodes, and hosts. In that sense, the communication system may be configured to operate according to predefined rules or procedures, such as specific standards that include, but are not limited to: Global System for Mobile Communications (GSM): Universal Mobile Telecommunications System (UMTS): Long Term Evolution (LTE), and/or other suitable 2G. 3G. 4G. 5G standards, or any applicable future generation standard (e.g., 6G): wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave. Near Field Communication (NFC) ZigBee. LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi. NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios. UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

Figure QQ2 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication. Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in Figure QQ2. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware: one or more stored computer programs, general-purpose processors, such as a microprocessor or digital signal processor (DSP), together with appropriate software: or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as “SIM card.” The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11. Code Division Multiplexing Access (CDMA). Wideband Code Division Multiple Access (WCDMA). GSM. LTE. New Radio (NR). UMTS. WiMax. Ethernet, transmission control protocol/internet protocol (TCP/IP), synchronous optical networking (SONET). Asynchronous Transfer Mode (ATM). QUIC. Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in Figure QQ2.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

Figure QQ3 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs). Operation and Maintenance (O&M) nodes. Operations Support System (OSS) nodes. Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM. WCDMA. LTE. NR. WiFi. Zigbee. Z-wave. LoRaWAN. Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in Figure QQ3 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

Figure QQ4 is a block diagram of a host QQ400, which may be an embodiment of the host QQ116 of Figure QQ1, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as Figures QQ2 and QQ3, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC). High Efficiency Video Coding (HEVC), Advanced Video Coding (AVC). MPEG. VP9) and audio codecs (e.g., FLAC. Advanced Audio Coding (AAC), MPEG. G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol. Real-Time Messaging Protocol (RTMP). Real-Time Streaming Protocol (RTSP). Dynamic Adaptive Streaming over HTTP (MPEG-DASH), etc.

Figure QQ5 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

Figure QQ6 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of Figure QQ1 and/or UE QQ200 of Figure QQ2), network node (such as network node QQ110a of Figure QQ1 and/or network node QQ300 of Figure QQ3), and host (such as host QQ116 of Figure QQ1 and/or host QQ400 of Figure QQ4) discussed in the preceding paragraphs will now be described with reference to Figure QQ6.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of Figure QQ1) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the discrepancy in applied application delay between the UE and the NW. In the embodiments, the UE signals its capability to the NW, e.g. whether the UE supports UE capability 1 or UE capability 2, thereby both the UE and NW are aware of which capability that the UE supports and may therefore assume that the UE applies an application delay accordingly. Otherwise, the NW may not know that the UE support capability 2 and hence is unaware that the UE may apply a application delay based on UE capability. If the NW assume that the UE uses a different application delay than it actually does then the NW is unaware of the SSSG that the UE is using. This may result in the UE may miss one of more PDCCH and thereby it may also miss some of the transmitted data.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio. VR or AR which it can broadcast, multicast or unicast to UEs. As other examples, the host QQ602 may be used for energy pricing, remote control of non-time critical electrical load to balance power generation needs, location services, presentation services (such as compiling diagrams etc, from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes: the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.: the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or dummy messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EMBODIMENTS

### Group A Embodiments

1. A method performed by a user equipment, UE, for search-space set group, SSSG, switching, the method comprising:
transmitting (201) UE capability information to a network node, wherein the transmitted UE capability information determines an application delay:
monitoring (202) PDCCH candidates according to a first SSSG:
receiving (203) an indication, from the network node, to switch from monitoring PDCCH candidates according the first SSSG to monitor PDCCH candidates according to a second SSSG:
monitoring (204) PDCCH candidates according to a second SSSG after the application delay.
   2. The method of 1 further comprising the step of:
receiving (205), from the network node, a radio resource control, RRC, configuration related to the SSSG switching, wherein the application delay value is comprised in the RRC configuration related to the SSSG switching.
   3. The method of embodiment 2, wherein the application delay value limited by a minimum predetermined value.
   4. The method of embodiment 1, wherein the application delay is obtained from a from a predetermined value which is dependent on the numerology and on UE processing capability.
   5. The method of embodiments 1 or 2, wherein UE capability information comprises information whether the UE has UE processing capability 1 or UE processing capability 2.
   6. The method of any previous embodiment, wherein the UE capability information comprises information about the search-space set group, SSSG, switching.
   7. The method of any previous embodiment, wherein the indication to switch from monitoring according the first SSSG to monitor PDCCH candidates according to a second SSSG is received in a DCI message.
   8. The method of any of the previous embodiments, further comprising:
providing user data; and
forwarding the user data to a host via the transmission to the network node.

### Group B Embodiments

9. A method performed by a network node for search-space set group, SSSG, switching, the method comprising:
receiving (301) UE capability information from a user equipment, UE, wherein the transmitted UE capability information determines an application delay and wherein the application delay determines a delay when the UE switches from monitoring PDCCH candidates according to a first SSSG to monitoring PDCCH candidates according to a second SSSG:
transmitting (302) an indication, to the UE, to switch from monitoring according the first SSSG to monitor PDCCH candidates according to a second SSSG.
   10. The method of 9 further comprising the step of:
transmitting (303), to the UE, a radio resource control, RRC, configuration related to the SSSG switching, wherein the application delay value is comprised in the RRC configuration related to the SSSG switching.
   11. The method of embodiment 10, wherein the application delay value limited by a minimum predetermined value.
   12. The method of embodiment 9, wherein the application delay is obtained from a from a predetermined value which is dependent on the numerology and on UE processing capability.
   13. The method of embodiments 9 or 10, wherein UE capability information comprises information whether the UE has UE processing capability 1 or UE processing capability 2.
   14. The method of any previous embodiment, wherein the UE capability information comprises information about the search-space set group, SSSG, switching.
   15. The method of any previous embodiment, wherein the indication to switch from monitoring according the first SSSG to monitor PDCCH candidates according to a second SSSG is received in a DCI message.
   16. The method of any of the previous embodiments, further comprising:
obtaining user data; and
forwarding the user data to a host or a user equipment.

### Group C Embodiments

17. A user equipment for search-space set group, SSSG, switching, comprising:
processing circuitry configured to perform any of the steps of any of the Group A embodiments; and
power supply circuitry configured to supply power to the processing circuitry.
   18. A network node for search-space set group, SSSG, switching, the network node comprising: processing circuitry configured to perform any of the steps of any of the Group B embodiments;
power supply circuitry configured to supply power to the processing circuitry.
   19. A user equipment (UE) for search-space set group, SSSG, switching, the UE comprising:
an antenna configured to send and receive wireless signals:
radio front-end circuitry connected to the antenna and to processing circuitry, and configured to condition signals communicated between the antenna and the processing circuitry:
the processing circuitry being configured to perform any of the steps of any of the Group A embodiments:
an input interface connected to the processing circuitry and configured to allow input of information into the UE to be processed by the processing circuitry:
an output interface connected to the processing circuitry and configured to output information from the UE that has been processed by the processing circuitry; and
a battery connected to the processing circuitry and configured to supply power to the UE.
   20. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to receive the user data from the host.
   21. The host of the previous embodiment, wherein the cellular network further includes a network node configured to communicate with the UE to transmit the user data to the UE from the host.
   22. The host of the previous 2 embodiments, wherein:
the processing circuitry of the host is configured to execute a host application, thereby providing the user data; and
the host application is configured to interact with a client application executing on the UE, the client application being associated with the host application.
   23. A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations of any of the Group A embodiments to receive the user data from the host.
   24. The method of the previous embodiment, further comprising:
at the host, executing a host application associated with a client application executing on the UE to receive the user data from the UE.
   25. The method of the previous embodiment, further comprising:
at the host, transmitting input data to the client application executing on the UE, the input data being provided by executing the host application,
wherein the user data is provided by the client application in response to the input data from the host application.
   26. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to transmit the user data to the host.
   27. The host of the previous embodiment, wherein the cellular network further includes a network node configured to communicate with the UE to transmit the user data from the UE to the host.
   28. The host of the previous 2 embodiments, wherein:
the processing circuitry of the host is configured to execute a host application, thereby providing the user data; and
the host application is configured to interact with a client application executing on the UE, the client application being associated with the host application.
   29. A method implemented by a host configured to operate in a communication system that further includes a network node and a user equipment (UE), the method comprising:
at the host, receiving user data transmitted to the host via the network node by the UE, wherein the UE performs any of the steps of any of the Group A embodiments to transmit the user data to the host.
   30. The method of the previous embodiment, further comprising:
at the host, executing a host application associated with a client application executing on the UE to receive the user data from the UE.
   31. The method of the previous embodiment, further comprising:
at the host, transmitting input data to the client application executing on the UE, the input data being provided by executing the host application,
wherein the user data is provided by the client application in response to the input data from the host application.
   32. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
   33. The host of the previous embodiment, wherein:
the processing circuitry of the host is configured to execute a host application that provides the user data; and
the UE comprises processing circuitry configured to execute a client application associated with the host application to receive the transmission of user data from the host.
   34. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of any of the Group B embodiments to transmit the user data from the host to the UE.
   35. The method of the previous embodiment, further comprising, at the network node, transmitting the user data provided by the host for the UE.
   36. The method of any of the previous 2 embodiments, wherein the user data is provided at the host by executing a host application that interacts with a client application executing on the UE, the client application being associated with the host application.
   37. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
   38. The communication system of the previous embodiment, further comprising:
the network node; and/or
the user equipment.
   39. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
   40. The host of the previous 2 embodiments, wherein:
the processing circuitry of the host is configured to execute a host application, thereby providing the user data; and
the host application is configured to interact with a client application executing on the UE, the client application being associated with the host application.
   41. The host of the any of the previous 2 embodiments, wherein the initiating receipt of the user data comprises requesting the user data.
   42. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of the steps of any of the Group B embodiments to receive the user data from the UE for the host.
   43. The method of the previous embodiment, further comprising at the network node, transmitting the received user data to the host.

### REFERENCES

TS 38.214 Technical Specification 3rd Generation Partnership Project; Technical Specification Group Radio Access Network; NR; Physical procedures for data
TS 38.331 Technical Specification 3rd Generation Partnership Project; Technical Specification Group Radio Access Network; NR; Radio Resource Control (RRC) protocol specification

1. A method performed by a user equipment UE, for search-space set group, SSSG, switching, the method comprising:
transmitting UE capability information to a network node, the transmitted UE capability information determining an application delay;
monitoring physical downlink control channel, PDCCH, candidates according to a first SSSG;
receiving an indication, from the network node, to switch from monitoring PDCCH candidates according the first SSSG to monitor PDCCH candidates according to a second SSSG; and
monitoring PDCCH candidates according to a second SSSG after the application delay.

2. The method of claim 1, further comprising:
receiving, from the network node, a radio resource control, RRC, configuration related to the SSSG switching, wherein the application delay value is comprised in the RRC configuration related to the SSSG switching.

3. The method of claim 2, wherein the application delay value is limited by a minimum predetermined value.

4. The method of claim 1, wherein the minimum predetermined value is dependent on the numerology and on UE processing capability.

5. The method of claim 1, wherein UE capability information comprises information whether the UE supports UE processing capability 1 or UE processing capability 2.

6. The method of claim 1, wherein the UE capability information comprises information about the search-space set group, SSSG, switching.

7. The method of claim 1, wherein the indication to switch from monitoring according the first SSSG to monitor PDCCH candidates according to a second SSSG is received in a DCI message.

8. The method of claim 1, further comprising:
providing user data; and
forwarding the user data to a host via the transmission to the network node.

9. A method performed by a network node for search-space set group, SSSG, switching, the method comprising:
receiving UE capability information from a user equipment, UE, the transmitted UE capability information determining an application delay, the application delay determining a delay when the UE switches from monitoring PDCCH candidates according to a first SSSG to monitoring physical downlink control channel, PDCCH, candidates according to a second SSSG; and
transmitting an indication, to the UE, to switch from monitoring according the first SSSG to monitor PDCCH candidates according to a second SSSG.

10. The method of claim 9, further comprising:
transmitting, to the UE, a radio resource control, RRC, configuration related to the SSSG switching, wherein the application delay value is comprised in the RRC configuration related to the SSSG switching.

11. The method of claim 10, wherein the application delay value is limited by a minimum predetermined value.

12. The method of claim 9, wherein the minimum predetermined value is dependent on the numerology and on UE processing capability.

13. The method of claim 9, wherein UE capability information comprises information whether the UE supports UE processing capability 1 or UE processing capability 2.

14. The method of claim 9, wherein the UE capability information comprises information about the search-space set group, SSSG, switching.

15. The method of claim 9, wherein the indication to switch from monitoring according the first SSSG to monitor PDCCH candidates according to a second SSSG is received in a DCI message.

16. The method of claim 9, further comprising:
obtaining user data; and
forwarding the user data to a host or a user equipment.

17. A user equipment, UE, for search-space set group, SSSG, switching, comprising:
processing circuitry configured to:
transmit UE capability information to a network node, the transmitted UE capability information determining an application delay;
monitor physical downlink control channel, PDCCH, candidates according to a first SSSG;
receive an indication, from the network node, to switch from monitoring PDCCH candidates according the first SSSG to monitor PDCCH candidates according to a second SSSG; and
monitor PDCCH candidates according to a second SSSG after the application delay.

18. A network node for search-space set group, SSSG, switching, the network node comprising:
processing circuitry configured to:
receive UE capability information from a user equipment, UE, the transmitted UE capability information determining an application delay, the application delay determining a delay when the UE switches from monitoring PDCCH candidates according to a first SSSG to monitoring physical downlink control channel, PDCCH, candidates according to a second SSSG; and
transmit an indication, to the UE, to switch from monitoring according the first SSSG to monitor PDCCH candidates according to a second SSSG.

19. The method of claim 2, wherein UE capability information comprises information whether the UE supports UE processing capability 1 or UE processing capability 2.

20. The method of claim 2, wherein the UE capability information comprises information about the search-space set group, SSSG, switching.
